(19) United States
(12) Patent Application Publication
(10) Pub. No.: US 2025/0324185 A1
(43) Pub. Date: Oct. 16, 2025

(54) PORTABLE ELECTRONIC DEVICE

(71) Applicant: LG ELECTRONICS INC., Seoul (KR)

(72) Inventors: Kanghee MIN, Seoul (KR); Wonseok JOO, Seoul (KR); Mansoo SIN, Seoul (KR); Sangkuk JEON, Seoul (KR)

(73) Assignee: LG ELECTRONICS INC., Seoul (KR)

(21) Appl. No.: 18/713,310

(22) PCT Filed: Nov. 29, 2021
(86) PCT No.: PCT/KR2021/017747

§ 371 Date: Oct. 16, 2024

(51) Int. Cl. H04R 1/10

(52) U.S. Cl. CPC H04R 1/1041; H04R 1/1016

(57) ABSTRACT

A portable electronic device comprises: a housing; and a user input portion located in the housing, wherein the user input portion comprises: a first input portion which is arranged to be in close contact with the inner surface of the housing and senses a touch input; and a second input portion which is arranged to be overlapped inside the first input portion and senses a push input, and thus, the portable electronic device can sense two types of inputs and can sufficiently secure the number of user commands which can be input.

### TECHNICAL FIELD

The present disclosure relates to a portable electronic device having a user input unit.

### BACKGROUND ART

With the development of wireless communication technology, the types of portable electronic devices are becoming diversified. Smaller-sized portable electronic devices such as laptops, tablets, and mobile terminals, as well as portable sound devices such as wireless earphones, are also being commercialized.

“Portable sound device” refers to a sound device configured to receive a sound signal from a terminal device and to transmit sound information collected through a microphone to the terminal device. Conventionally, portable sound devices have adopted wired communication technology in which a terminal of a portable sound device is inserted into an ear port of a terminal device so as to receive sound signals. Recently, demand for wireless-communication-type portable sound devices is increasing due to convenience in mobility and use thereof.

A portable sound device may be provided with a sound output unit in order to fulfill various functions, including those of music reproduction, telecommunications, and the like. Such a portable sound device is capable of being connected to a base station by itself for telecommunications or of being directly connected to an external server so as to receive sound data. In addition, such a portable sound device is capable of fulfilling the above functions by being paired with another terminal device.

Portable sound devices, including a headphone-type portable sound device configured to have a band shape so as to be worn on a user's head, an ear-hook-type portable sound device, and an ear-fit-type portable sound device, which are designed in consideration of portability, have been developed.

Because portable sound devices, which are designed to be worn on a user's head or to be hung on a user's neck, have a somewhat large volume, demand for an earbud-type portable sound device, which is constructed such that only earbuds, which are put into a user's ears, are configured so as to be operated wirelessly, and a cradle serving as a case capable of charging the earbuds and or storing the earbuds therein is additionally provided, is recently increasing. Although the earbud-type portable sound device is convenient to use, there is a difficulty in disposition of parts such as a battery, a user input unit, and the like because the portable sound device is small.

### DISCLOSURE

### Technical Problem

An object of the present disclosure is to provide a portable sound device provided with a user input unit capable of detecting two types of inputs.

### Technical Solutions

In accordance with an aspect of the present disclosure, a portable electronic device may include a housing; and a user input unit located inside the housing, wherein the user input unit includes a first input unit disposed in close contact with an inner surface of the housing and detecting a touch input; and a second input unit disposed to overlap the inside of the first input unit and detecting a push input.

The user input unit may include a flexible substrate inn which the first input unit and the second input unit are mounted; and a connector formed to connect a main substrate mounted in the housing to the first input unit and the second input unit.

The flexible substrate may include a first substrate, one surface of which is provided with the first input unit mounted thereon, and the other surface of which is provided with the second input unit mounted thereon. One surface of the first substrate may be disposed in close contact with the inner surface of the housing.

The first substrate may include a first insulation layer, a second insulation layer, and a ground layer. The first insulation layer is located at one surface of the first substrate, and includes the first input unit disposed thereon. The second insulation layer is located at the other surface of the first substrate, and includes the second input unit disposed thereon. The ground layer is disposed between the first insulation layer and the second insulation layer.

The portable electronic device may further include a carrier inserted into the housing, and a metal spring formed to cover the second input unit. The carrier may be provided with the user input unit seated therein. The metal spring may maintain a predetermined distance from the other surface of the first substrate, and may be in contact with the carrier.

The second input unit may detect a change in distance with the metal spring and may determine the detected distance as the push input.

The portable electronic device may include a dielectric material having elasticity and located between the second input unit and the metal spring.

The second input unit may include a first electrode and a second electrode spaced apart from each other by a predetermined distance at the other surface of the first substrate. The metal spring may be grounded, and a change in distance to the metal spring may be sensed based on a change in the magnitude of an electric field between the first electrode and the second electrode.

The second input unit may include a first electrode located at the other surface of the first substrate, and a second electrode located at the other surface of the first substrate and connected to the metal spring. A change in distance to the metal spring may be sensed based on a change in the magnitude of an electric field between the first electrode and the metal spring.

The flexible substrate may include a second substrate disposed opposite to the other surface of the first substrate, and a third substrate formed to connect the first substrate to the second substrate. The second input unit may include a first electrode located at the other surface of the first substrate and a second electrode formed to face the first electrode and located at the second substrate. The push input may be detected based on a change in a distance between the first electrode and the second electrode.

The portable electronic device may include a dielectric material having elasticity and disposed between the first substrate and the second substrate.

The portable electronic device may include a conductive pad located at the other surface of the first substrate and adjacent to the first electrode; and a control unit configured to periodically and alternately activate the first input unit and the second input unit, wherein the control unit periodically controls a potential of the first electrode and a potential of the conductive pad to be equal to each other when the first input unit is activated.

The housing may include a main body in which a sound output unit is mounted; and an extension unit having one end coupled to the main body and provided with the user input unit mounted therein.

The first input unit may include a plurality of electrodes arranged in a longitudinal direction of the extension unit.

### Advantageous Effects

As is apparent from the above description, the portable sound device according to the embodiments of the present disclosure can detect two types of inputs, thereby ensuring a sufficient number of user commands that can be input.

In addition, the embodiments of the present disclosure may provide a portable sound device having an improved structure that has stable performance while ensuring assemblability.

The additional scope within which the present disclosure is applicable will be apparent from the following detailed description. However, since various alternatives, modifications, equivalents and other embodiments that are included within the spirit and scope of the present disclosure will be appreciated by those skilled in the art, the detailed description and specific embodiments, such as preferred embodiments of the present disclosure, should be construed as merely illustrative.

### DESCRIPTION OF DRAWINGS

FIG. 1 is a block diagram illustrating the configuration of the portable sound device according to the present disclosure.

FIG. 2 is a perspective view illustrating the configuration of the portable sound device according to the present disclosure.

FIG. 3 is a view illustrating the disposition of a user input unit of the portable sound device according to an embodiment of the present disclosure.

FIG. 4 is a conceptual view illustrating a first input unit and a second input unit of the portable sound device according to the present disclosure.

FIG. 5 is a view illustrating a process of assembling the user input unit of the portable sound device according to an embodiment of the present disclosure.

FIGS. 6 and 7 are views illustrating various embodiments of the first input unit of the portable sound device according to the present disclosure.

FIG. 8 is a view illustrating the disposition of the user input unit of the portable sound device according to another embodiment of the present disclosure.

FIG. 9 is a view illustrating the user input unit of the portable sound device according to another embodiment of the present disclosure.

FIGS. 10 to 14 are views illustrating various modifications of the user input unit of the portable sound device according to another embodiment of the present disclosure.

### BEST MODE

A description will now be given in detail according to the exemplary embodiments disclosed herein, with reference to the accompanying drawings. For the sake of brevity of description with reference to the drawings, the same or equivalent components may be denoted by the same reference numbers, and a description thereof will not be repeated. In general, suffixes such as “module” and “unit”, when are used in the following description, may be used to refer to elements or components for easy preparation of the specification. The use of such suffixes herein is merely intended to facilitate the description of the specification, and the suffixes do not imply any special meaning or function. Furthermore, in the following description of embodiments disclosed herein, if it is decided that a detailed description of known functions or configurations related to the invention would make the subject matter of the invention unclear, such detailed description is omitted. The accompanying drawings are used to assist in easy understanding of various technical features, and it should be understood that the embodiments presented herein are not limited by the accompanying drawings. As such, the present disclosure should be construed to extend to any alterations, equivalents, and substitutes, in addition to those which are particularly set out in the accompanying drawings.

It will be understood that although the terms “first”, “second”, etc. may be used herein to describe various elements, these elements should not be construed as being limited by these terms. These terms are only used to distinguish one element from another.

It should be understood that, when an element is referred to as being “connected with” another element, there may be intervening elements present, or the element may be directly connected with the another element. In contrast, it should be understood that, when an element is referred to as being “directly connected with” another element, there are no intervening elements present.

A singular representation may include a plural representation unless the context clearly indicates otherwise.

Terms such as “includes” or “has” used herein should be considered as indicating the presence of various features, numbers, steps, operations, elements, components or combinations thereof disclosed in the specification, but it should be understood that the presence or addition of one or more other features, numbers, steps, operations, elements, components or combinations thereof is not excluded.

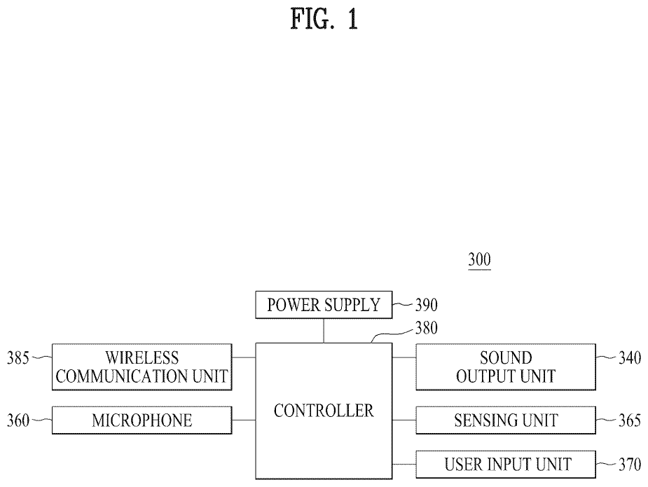

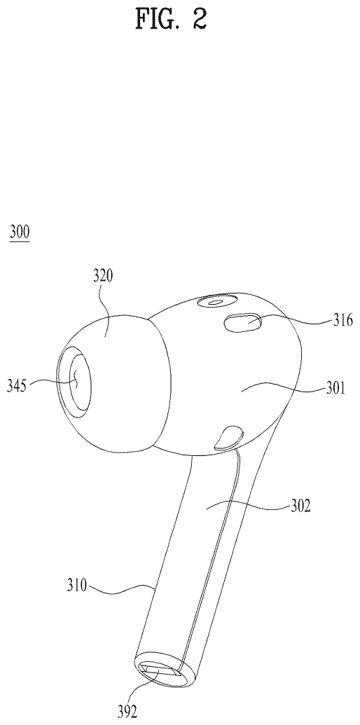

FIG. 1 is a block diagram of a portable sound device 300 according to an embodiment of the present disclosure. FIG. 2 is a perspective view illustrating the portable sound device 300 according to an embodiment of the present disclosure. The portable sound device 300 according to the present disclosure may include a controller 380, a wireless communication unit 385, a sound output unit 340, a sensing unit 365, a microphone 360, a user input unit 370, and a power supply 390, and may be received in a housing 310.

As illustrated in FIG. 2, the housing 310 may include a main body 301, on which parts such as a sound output unit are mounted, and an extension 302 which extends from the main body 301 so as to be exposed to the outside of a user's ear. The extension 302 may be exposed to the outside, and may be provided therein with the input unit 370, the microphone 360, and the wireless communication unit 385.

The controller 380) may control the sound output unit 340 to be activated in response to a sound signal received through the wireless communication unit 385, and may control the sound output unit 340 to transmit the sound collected through the microphone 360 through the wireless communication unit 385 or to provide more clear sound by using the noise from the sound collected through the microphone 360.

In the controller 380, a printed circuit board may be positioned in a housing 301. Because a plurality of ICs are mounted on the printed circuit board, there is a problem in that the thickness thereof is increased when the printed circuit board is disposed so as to overlap a battery. Accordingly, a flexible circuit board may be used in order to dispose the printed circuit board so as not to overlap the battery and to realize mounting and connection of some components, such as the microphone 360, the user input unit 370, and the sound output unit 340.

The portable sound device according to the present disclosure may include the wireless communication unit 385 configured to receive sound signals via wireless communication. Although the wireless communication unit 385 may itself be connected to a mobile communication base station to perform communication, the wireless communication unit 385 may generally be connected to an external device such as a mobile terminal through short-range communication.

Examples of the short-range communication may include at least one of Bluetooth™. RFID (Radio Frequency Identification), Infrared Data Association (IrDA), Ultra-Wideband (UWB), ZigBee, Nearfield Communication (NFC), Wi-Fi (Wireless-Fidelity), Wi-Fi Direct, and Wireless USB (Wireless Universal Serial Bus).

The sound output unit 340, which is a device configured to output sound according to a sound signal, may be put into a user's ear so as to serve to transmit sound. The sound output unit 340 may output sound based on the sound signals received through the wireless communication unit 385, and the housing 310 may be provided therein with a sound hole 345 through which the sound output from the sound output unit 340 is output.

The portable sound device according to the present disclosure may be of an earbud type, in which the sound output from the sound output unit 340 is directly transmitted to the ear canal of a user, and may include an ear tip surrounding the periphery of the sound hole 345 in order to improve wearing comfort and to block external noises.

The sound output unit 340 may further include a resonance hole 316 for resonance, in addition to the sound hole 345 through which sound is output. Here, the perceived sound may change depending on the position and size of the resonance hole 316.

The sensing unit 365 may detect conditions inside and outside the portable sound device, and may use the result of detection in control of the portable sound device. The sensing unit 140 may include at least one of a proximity sensor 141, an illumination sensor 142, a touch sensor, a motion sensor, an RGB sensor, an infrared (IR) sensor, an optical sensor, a battery gauge, or an environmental sensor (for example, a barometer, a hygrometer, a thermometer, a radioactive sensor, a heat detector, a gas detector, or the like).

However, because the size of the portable sound device 300 is limited, the number of sensing units 365 may be minimized, and ambient information (temperature, illuminance, and the like) may be obtained through a terminal connected via the wireless communication unit 385.

The microphone 360 may process an external sound signal into electric voice data. The processed voice data may be transmitted to an external terminal device or an external server through the wireless communication unit 385. The microphone 360 may realize various denoising algorithm for removing noise generated in the course of receiving external sound signals.

Such noise removal technology is referred to as active noise control (ANC), noise canceling, or active noise reduction (ANR). ANC is technology for blocking noise by analyzing noise collected through a microphone and outputting an interference signal capable of cancelling the noise.

The user input unit 370 is a unit for inputting a user command. Although it is possible to obtain information through a mobile terminal connected to the wireless communication unit 385, the simple user input unit 370 may be provided so as to allow simple manipulation to be performed without a mobile terminal.

For example, there is need for an input unit capable of allowing a user to select playback/pause of sound, to determine whether or not a call signal is received upon transmission of the call signal, and to control the volume of sound. Here, a button-type user input unit, which is capable of being pushed, is necessary in the case of simple function conversion, and a slide-type user input unit, which is capable of detecting input in a slide manner, is necessary when there is a need for stepwise control such as volume control.

Because the user input unit 370) must be exposed to the outside, the user input unit 370 may be positioned at the side opposite the sound hole 345 in the device body or at the extension 302. The present disclosure is directed to a user input unit positioned at the extension 302. Hereinafter, the user input unit will be described in detail with reference to the accompanying drawings.

The user input unit 370, which will be described hereinafter, may be applied not only to a sound device including the sound output unit 340 but also to other small-sized portable electronic devices. For convenience of explanation, the user input unit is described based on an electronic device including the sound output unit.

The user input unit 370 according to the embodiment may include a first input unit 371 configured to detect touch input and a second input unit 372 configured to detect push input. The first input unit 371 may include a plurality of electrodes for detecting touch input in order to detect slide input in the direction in which the electrodes are arranged. When a user's finger moves in a longitudinal direction while touching the extension 302, it is possible to detect slide input and to perform stepwise control of, for example, volume.

The second input unit 372 configured to detect push input may include a force sensor, which has a small size and is capable of detecting push input.

The first input unit 371 is capable of detecting touch input in such a manner as to detect variation in the potential of the electrode due to a user's finger when the user's finger comes into contact with the electrode, and is capable of detecting slide input in such a manner as to detect electrodes with which a user's finger sequentially comes into contact.

The second input unit 372 may include a force sensor. The force sensor may use a strain gauge, an MEMS (MicroElectroMechanical Systems) ultrasonic sensor, an inductive sensor including a coil, an electrode sensor, or the like.

The strain gauge may detect push input in such a manner as to detect variation in the resistance of a resistance wire, which is disposed in a zigzag pattern, caused when the length of the resistance wire is changed due to pressure. In order to detect the direction of pressure, a plurality of strain gauges may be used. In order to detect only whether or not strain is present, the second input unit 372 may be embodied as a single strain gauge.

The MEMS ultrasonic sensor, which is an ultrasonic sensor capable of recognizing the three-dimensional shape of an object in air by combining a thermally-induced ultrasonic source that uses the thermal properties of nanocrystal porous silicon with a MEMS-type condenser microphone, is capable of detecting strain.

The inductive sensor including a coil, which includes a coil and a metal object. is capable of detecting push input by detecting variation in current flowing through the coil caused when the distance between the coil and the adjacent metal object is changed upon application of pressure by a user.

The electrode sensor, which is a force sensor including two electrodes, which are spaced apart from each other with a predetermined gap therebetween, is capable of detecting push input by detecting variation in the intensity of an electrical field formed between the two electrodes that occurs when pressure is applied to the force sensor.

Although the following embodiment will be described based on an electrode sensor, the user input unit 370 may also be embodied as another type of force sensor.

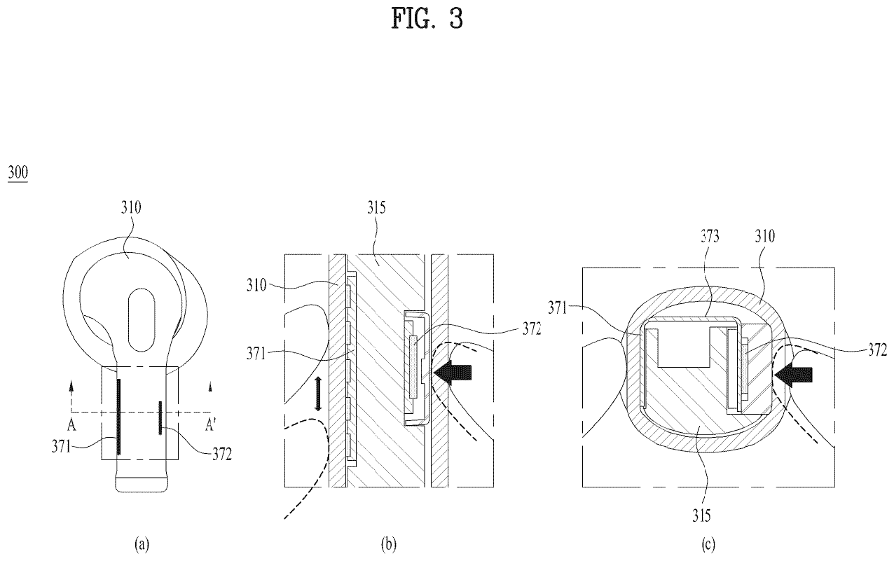

FIG. 3 is a view illustrating disposition of the user input unit 370 of the portable sound device 300 according to an embodiment of the present disclosure. Referring to FIG. 3(a), the user input unit 370 may be positioned at the extension 302, and the first input unit 371 and the second input unit 372 may be positioned opposite each other.

FIG. 3(b) is a cross-sectional view of the dotted square portion in FIG. 3(a). The first input unit 371, which is positioned at one side of the sound device, may detect slide input through the plurality of electrodes each configured to detect touch input of a user, and the second input unit 372, which is positioned at the opposite side of the sound device, may detect push input.

FIG. 3(c) is a cross-sectional view taken along line A-A′ in FIG. 3(a). The first input unit 371 may be closely disposed on the inner surface of the housing 310, and the second input unit 372 may be disposed in the state of being spaced apart from the housing 310 so as to detect push input by detecting variation in the distance between the second input unit 372 and the housing 310.

Although the extension 302 is illustrated as having a cylindrical form, the extension 302 may have a flat surface so as to realize a constant distance between the first input unit 371 and the housing 310. The second input unit 372 may also have a flat surface so as to allow a user to recognize the position of the second input unit 372 using his/her sense of touch.

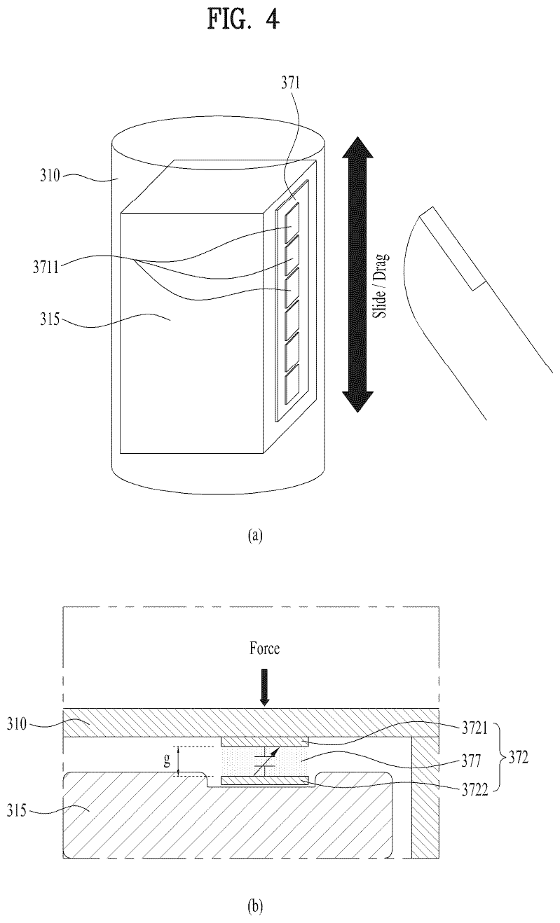

FIG. 4 is a conceptual view illustrating the first input unit 371 and the second input unit 372 of the portable sound device 300 according to the present disclosure. FIG. 4(a) illustrates the first input unit 371, and FIG. 4(b) illustrates the second input unit 372.

As illustrated in FIG. 4(a), the first input unit 371 includes a plurality of electrodes 3711, which are sequentially arranged in one direction. When a user touches one of the plurality of electrodes 3711, the resistance of the electrode is changed, whereby the first input unit 371 detects the touch input. When sequential touch inputs on the plurality of electrodes 3711 are detected, the first input unit 371 may recognize the sequential touch inputs as slide touch input, and consequently perform a function such as volume control or the like.

The first input unit 371 may be closely disposed on the inner surface of the housing 310 such that the distance between the electrode and a user's finger is constant when the user touches the housing 310.

As illustrated in FIG. 4(b), the second input unit 372 may include a pair of electrodes 3721 and 3722. The first electrode 3721 and the second electrode 3722 may be disposed with a predetermined gap defined therebetween so as to detect variation in the distance between the pair of electrodes.

The first electrode 3721 may be in close contact with the inner surface of the housing 310, and the second electrode 3722 may be positioned on a carrier 315 positioned inside the housing 310. When a user presses the housing 310, variation in an electrical field between the first electrode 3721 and the second electrode 3722 and consequent variation in electrostatic capacitance occur due to minute displacement of the housing 310. The controller may detect whether or not user input is applied based on the variation in electrostatic capacitance between the first electrode 3721 and the second electrode 3722.

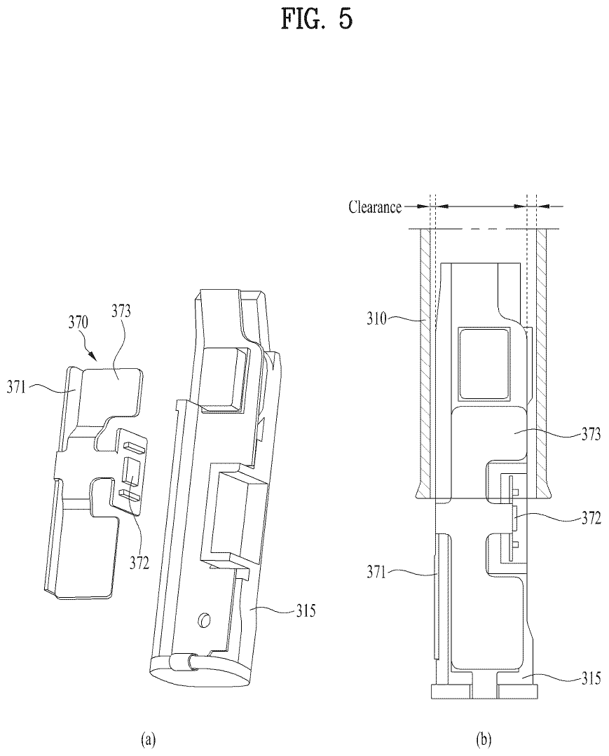

FIG. 5 is a view illustrating a process of assembling the user input unit 370 of the portable sound device 300 according to an embodiment of the present disclosure. The user input unit 370 may be formed on a single flexible board 373. The flexible board 373 may include a first board 3731 at which the first input unit 371 is positioned and a second board 3732 at which the second input unit 372 is positioned. The first board 3731 and the second board 3732 may be positioned opposite each other.

The portable sound device 300 may include a carrier 315 on which the user input unit 370 is seated and at which a battery, a microphone, an antenna, and the like are disposed. As illustrated in FIG. 5(b), the carrier 315 may be inserted into the lower portion of the cylindrical form corresponding to the extension 302.

In order to prevent the carrier 315 from catching on the inner surface of the housing 310 and thus from becoming difficult to insert into the housing 310 when the carrier 315 is inserted into the housing 310 or in order to prevent the user input unit 370 from breaking due to friction against the housing 310 when the user input unit 370 is assembled, there is a need to provide a clearance for erection tolerance between the housing 310 and the carrier 315.

When a space is provided between the housing 310 and the carrier 315 for erection tolerance, there may be the case in which the gap required for detection of pressure of the second input unit 372 is not stably maintained. Accordingly, an elastic member, which is deformed upon compression and is then restored to the original shape, may be used.

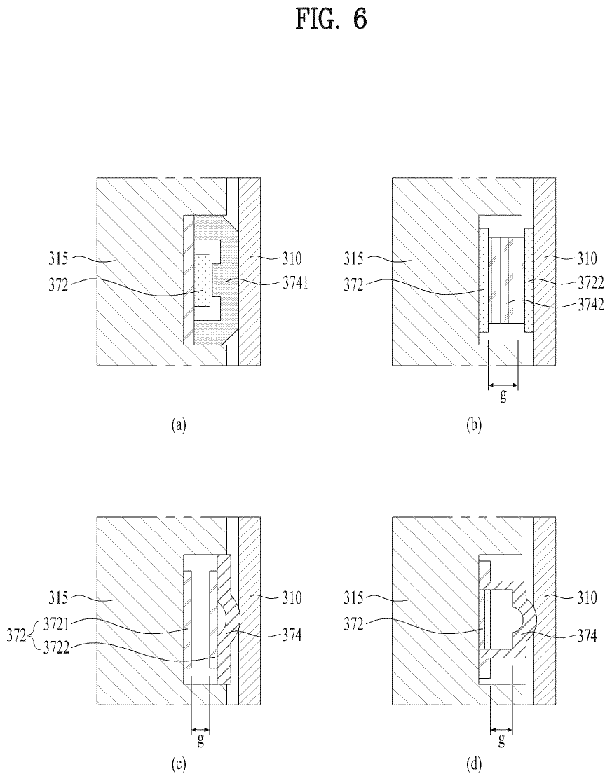

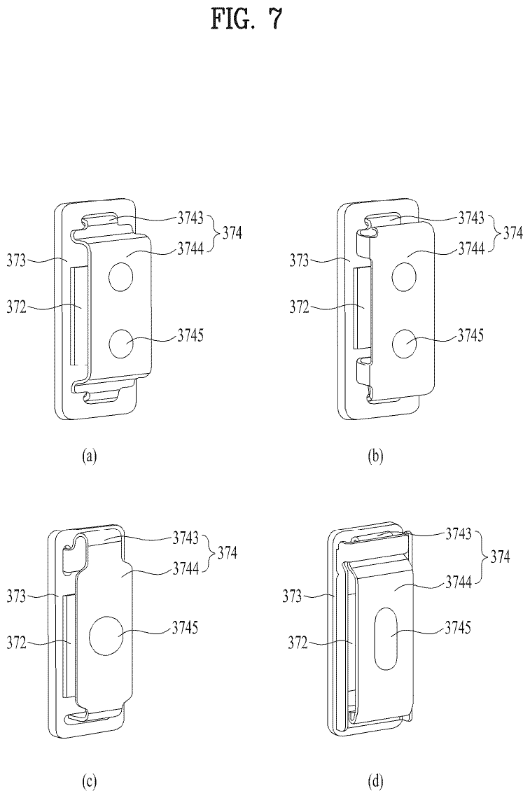

FIGS. 6 and 7 are views illustrating various embodiments of the first input unit 371 of the portable sound device 300 according to an embodiment of the present disclosure. As illustrated in FIG. 5(a), an elastic cap 3741, which is made of an elastic material such as rubber or silicone, may be provided between the housing 310 and the second input unit 372. The elastic cap 3741 may include an actuator, which projects to press the second input unit 372.

Alternatively, as illustrated in FIG. 6(b), a foam tape 3742, which includes elastic foam, may be provided so as to maintain a distance between the housing 310 and the second input unit 372. Specifically, the foam tape 3742 may be disposed between a pair of electrodes of the second input unit 372 so as to sense variation in the distance between the electrodes caused by application of pressure.

FIGS. 6(c) and 6(d) illustrate an embodiment in which a metal spring 374 is used as an elastic member. The metal spring 374 may be compressed when the carrier 315 is inserted into the housing 310, and may be restored to the original shape after assembly, thus maintaining the distance between the housing 310 and the second input unit 372. The metal spring 374 may be compressed when pressure is applied to the second input unit 372 by a user, and may be restored to the original shape after release of the application of the pressure.

FIG. 6(c) illustrates an embodiment in which electrodes forming a pair are respectively positioned at the metal spring 374 and the carrier 315. FIG. 6(d) illustrates an embodiment in which the metal spring 374 is electrically connected to a board on which the second input unit 372 is mounted and the metal spring 374 itself serves as an electrode.

FIG. 7 illustrates various embodiments of the second input unit 372 including the metal spring 374 shown in FIGS. 6(c) and 6(d) in which the metal spring 374 is coupled to a flexible board 373 on which the second input unit 372 is mounted. The metal spring 374 may include a cover portion 3744 covering the second input unit 372 and a connection portion 3743 connected to the flexible board 373.

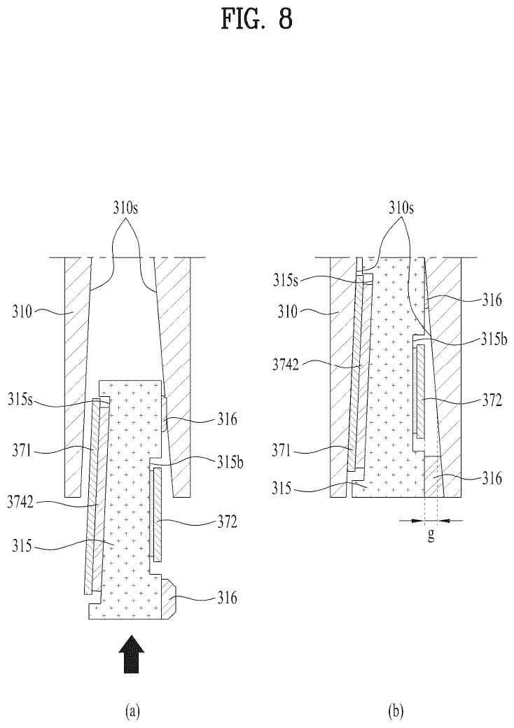

As illustrated in FIG. 7, the connection portion 3743 may be bent so as to be restored to the original shape even when the connection portion 3743 is deformed by pressure. The metal spring 374 may further include an actuator 3745 projecting therefrom. As illustrated in FIGS. 7(a) and 8(b), the metal spring 374 may include two actuators in order to embody two second input units 372.

In the case in which the portable sound device 300 has a small size, as in an earbud-type portable sound device, the portable sound device may include only a single second input unit 372, as illustrated in FIGS. 7(c) and 7(d).

When the metal spring 374 is provided and inserted while pressed, the metal spring 374 provides force to press the carrier 315 in the direction of the first input unit 371, so that the first input unit 371 can be brought into close contact with the inner wall of the housing. However, when the metal spring 374 is inserted into the housing 310, the metal spring 374 can no longer be inserted in a compressed state and, as such, the metal spring 374 and the carrier 315 are attached to the inner surface of the housing 310. In other words, there is a problem that the assembly tolerance disappears and the assembly quality deteriorates.

FIG. 8 is a view illustrating arrangement of the user input unit 370 of the portable sound device 300 according to another embodiment of the present disclosure. In FIG. 8, an inclined surface is formed on the inner surface of the carrier 315 and the housing 310.

That is, a first inclined surface 310s may be formed so that the internal space of the housing 310 becomes smaller in the direction from the inlet (i.e., a lower portion in the drawing) to the inside (i.e., an upper portion in the drawing) of the housing 310. The carrier 315 may also have a second inclined surface 315s corresponding to the first inclined surface 310s inside the housing 310, so that an upper diameter of the carrier 315 can be smaller than a lower diameter thereof. For convenience of injection molding of the housing 310, the first inclined surface 310s with the same angle can be placed around the entire circumference of the housing 310, but the second inclined surface 315s may not be formed on all surfaces facing the first inclined surface 310s and may be formed only on a first seating unit where the first input unit 371 is seated as shown in FIG. 8.

The first input unit 371 is attached to the first seating unit including the second inclined surface 315s of the carrier 315 and placed parallel to the inner surface of the housing 310, and the carrier 315 is attached to the housing 310 so that the portable sound device 100 can be assembled.

As the carrier 315 is inserted into the housing 310, the distance between the first input unit 371 and the inner surface of the housing 310 decreases, and when the carrier 315 is completely stored inside the housing 310 as shown in FIG. 8(b), the first input unit 371 may be in close contact with the first inclined surface 310s of the housing 310.

When the adhesive tape 3742 that attaches the first input unit 371 to the carrier 315 has elasticity, the first input unit 371 compensates for the tolerance and may be pressed such that the first input unit 371 is in close contact with the inner surface of the housing 310.

Since the first input unit 371 has a plurality of electrodes arranged in the longitudinal direction of the housing 310, it is advantageous for the distance between each electrode and the user's finger to be constant in order for each electrode to detect the same touch input and receive a slide input. Accordingly, the first inclined surface 310s on the inner surface of the housing 310 can be configured to have a minimum angle, and additionally, an inclined surface corresponding to the inner surface can be formed on the outer surface of the housing 310.

Meanwhile, the second input unit 372 requires a gap (g) spaced apart from the housing 310 to sense pressure. Accordingly, the seating surface of the carrier 315 on which the second input unit 372 is seated may include a concave second seating unit 315b on which the second input unit 372 is seated such that the seating surface of the carrier 315 is spaced apart from the inner surface of the housing 310.

When the user presses the second input unit 372, the housing 310 facing the second input unit 372 may be bent and may further include an elastic member 316 placed between the housing 310 and the carrier 315 so that the housing 310 can be restored to an original position thereof. The above-mentioned metal spring can also be used as the elastic member 316, but when the housing 310 has an inclined surface as in the embodiment shown in FIG. 8, the gap of the upper portion and the gap of the lower portion are different in size from each other, so that the gap (g) can be maintained by interposing the elastic members 316 having different sizes at the upper and lower portions of the second input unit 372.

Although the drawing shows that the second seating surface 315b on which the second input unit 372 is seated is configured in a vertical direction, the scope or spirit of the present disclosure is not limited thereto, and the second seating surface 315b may also be configured to have an inclined surface like the first seating surface 315s of the first input unit 371.

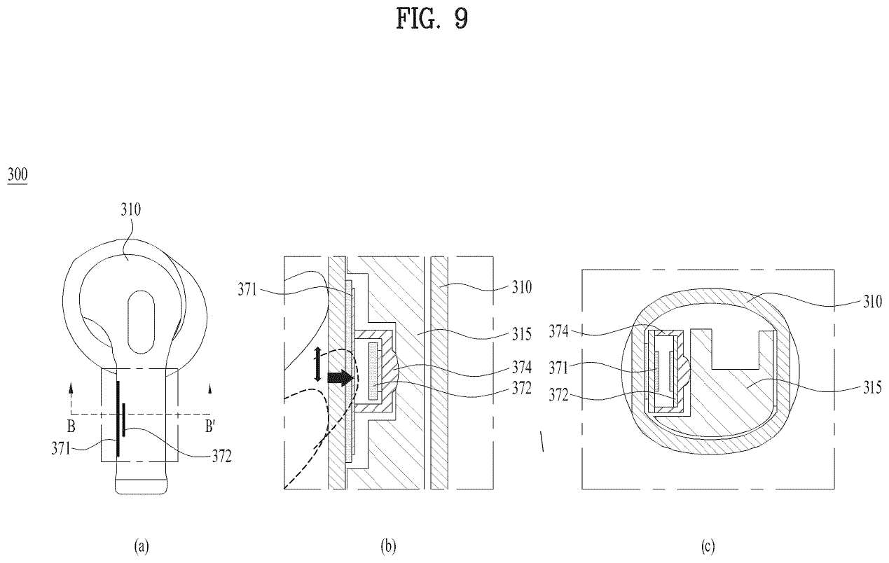

FIG. 9 is a view illustrating the disposition of the user input unit 370 of the portable sound device 300 according to another embodiment of the present disclosure. As illustrated in FIG. 9(a), the user input unit 370 according to the embodiment may be configured such that the first input unit 371 and the second input unit 372 are positioned at the same side of the extension 302.

The previous embodiment has a problem in which the first input unit and the second input unit of the user input unit 370 are respectively disposed at two sides of the extension 302 and thus the proportion of the limited space occupied by the user input unit 370 increases, thereby causing the amount of space for accommodating other parts such as a battery and the like to be insufficient or requiring the size of the extension 302 to be increased.

Accordingly, the first input unit 371 and the second input unit 372 may be disposed at the same side of the extension 302 in order to reduce the size of the user input unit 370 to thus improve the amount of available space inside the extension 302, as illustrated in FIG. 9. As illustrated in FIG. 9(b), a user may provide input through the first input unit 371 by touching the side of the extension 302 in a slide touch manner, and may also provide push input through the second input unit 372 by pressing the side of the extension 302.

FIG. 9(c) is a cross-sectional view taken along line B-B′ in FIG. 9(a). Here, the first input unit 371 may be closely disposed at the housing 310 and the second input unit 372 may be disposed inside the first input unit 371. The portable sound device may include an elastic member such as the metal spring 374 in order to provide a gap between the first input unit 371 and the second input unit 372.

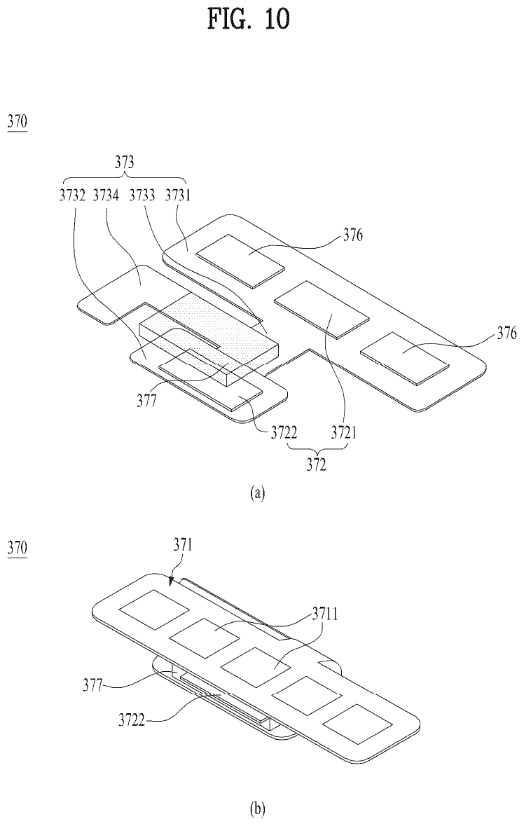

FIG. 10 is a conceptual view of the user input unit 370 shown in FIG. 9. The first input unit 371 may include a plurality of electrodes, which are positioned on one surface (the outer surface) thereof. The plurality of electrodes may be arranged in the longitudinal direction of the extension 302.

The second input unit 372 may be positioned inside the first input unit 371 so as to detect an electrical field, that is, the electric capacitance between two electrodes, which are spaced apart from each other by the other surface of the first input unit 371. As illustrated in FIG. 9(b), when a user presses the outer surface of the housing 310 of the extension 302, the distance between the pair of electrodes is decreased, thereby causing variation in the electric capacitance.

FIG. 10 is a conceptual view illustrating an embodiment of the user input unit 370, in which FIG. 10(a) illustrates the user input unit 370 which is unfolded and FIG. 10(b) illustrates the user input unit 370 which is folded so as to be mounted in the housing 310. As illustrated in FIG. 9(a), the user input unit 370 may be disposed on the flexible board 373, and the electrodes of the first input unit 371 and the second input unit 372 may be disposed on the surface of the flexible board 373.

As illustrated in FIG. 10(b), the flexible board 373 may be folded such that the two parts thereof face each other, and may be mounted in the housing 310. Alternatively, the first input unit 371 and the second input unit 372 may be provided on a single flexible board 373.

The flexible board 373 may include the first board 3731, on one surface of which the plurality of electrodes are positioned and the second board 3732, which is disposed so as to face the other surface of the first board 3731. The second input unit 372 may include the first electrode 3721, which is positioned on the other surface of the first board 3731, and the second electrode 3722, which is positioned at the second board 3732 and faces the first electrode 3721 when the flexible board 373 is folded as illustrated in FIG. 10(b).

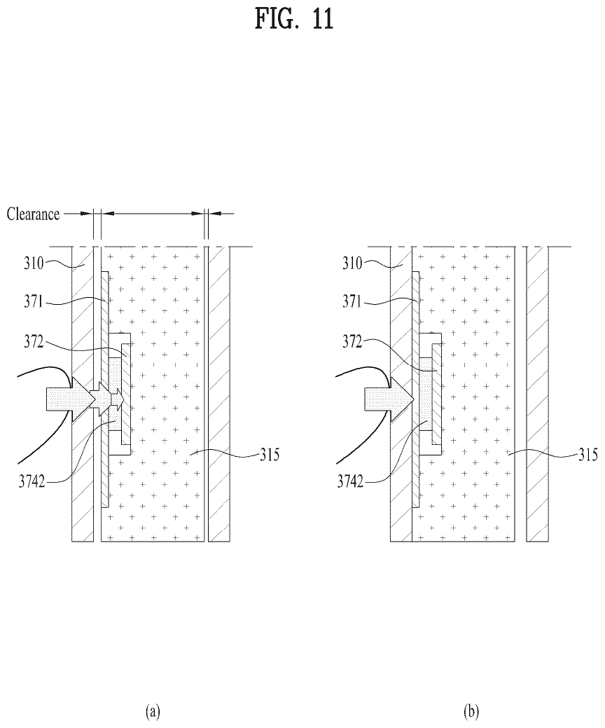

FIG. 11 is a diagram illustrating a problem encountered in the arrangement according to the embodiment of FIG. 9. As shown in FIG. 11(a), the first input unit 371 is not in close contact due to the gap formed to facilitate assembly, and thus the input accuracy of the first input unit 371 is reduced. In addition, since the second input unit 372 is arranged to overlap the first input unit 371, force is transmitted through several layers, making it difficult to sense a push input from the second input unit 372.

As shown in FIG. 11(b), when the first input unit 371 and the housing 310 are placed in close contact to improve the sensitivity of the first input unit 371, deformation of the housing 310 does not occur, so that it is difficult to sense pressure generated in the second input unit 372. The first input unit 371 must be in close contact with the housing 310, but the housing 310 must be able to deform in response to pressure so that the second input unit 372 can detect the user's push input.

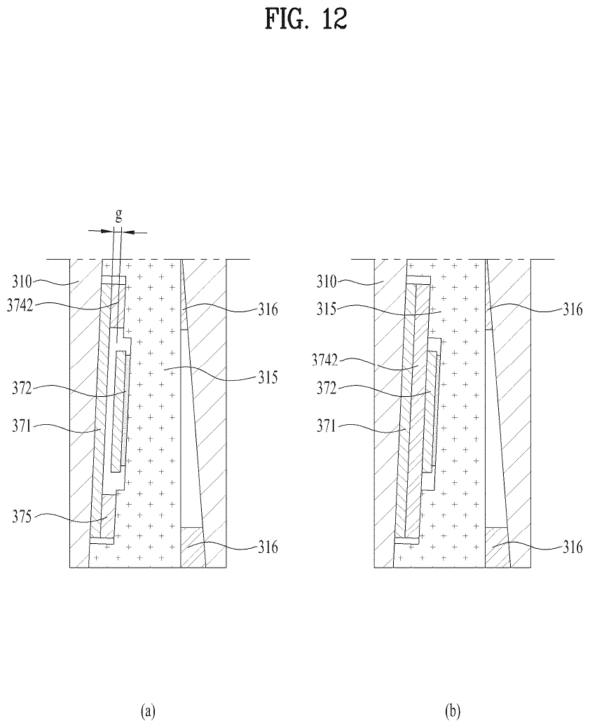

In order to solve the problem, FIG. 12 shows that the first input unit 371 is placed in close contact with the housing 310 and has a predetermined gap (g) between the second input unit 372 and the first input unit 371.

An elastic pad may be interposed between the back surface of the first input unit 371 and the carrier 315 as shown in FIG. 12(a) to maintain the gap (g) between the first input unit 371 and the second input unit 372. Alternatively, the first input unit 371 can be attached to the carrier 315 using an elastic adhesive tape 3742.

Alternatively, as shown in FIG. 12(b), the first input unit 371 and the second input unit 372 can be attached to each other using an adhesive tape 3742 having elasticity.

The second input unit 372 is placed on the back surface of the first input unit 371, the carrier 315 and the second input unit 372 are placed to have a gap therebetween, and the second input is also bent when the housing 310 is bent.

At this time, the second input unit 372 may include a MEMS force sensor designed to detect bending deformation or a force sensor designed to use a deformation meter, etc.

Even in the embodiment in which the first input unit 371 and the second input unit 372 are located on one side, a first inclined surface 310s is formed on the inner surface of the housing 310 to facilitate insertion of the carrier 315, and the carrier 315 may include a second inclined surface 315s corresponding to the first inclined surface 310s.

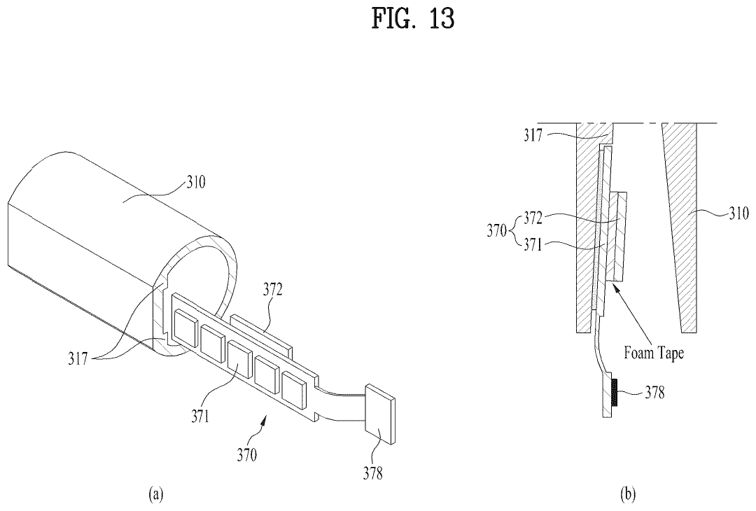

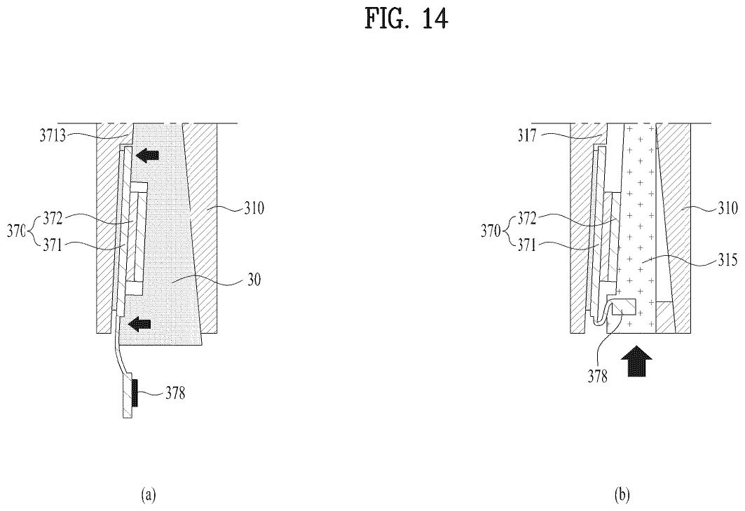

The embodiments of FIGS. 13 and 14 are similar to the above-described embodiment in that both the first input unit 371 and the second input unit 372 are disposed on one side, but the first input unit 371 can be in closer contact with the housing 310 using the adhesive tape 3742, etc.

When the housing 310 and the first input unit 371 are attached to each other after the user input unit 370 is coupled to the carrier 315, it is difficult for the first input unit 371 to adhere to the inner surface of the housing 310 due to the elastic material located on the back surface of the first input unit 371.

Therefore, in the portable sound device according to the present embodiment, the user input unit 370 may first be inserted into the housing 310, as shown in FIG. 13(a), and then the carrier 315 may be inserted into the housing 310, as shown in FIG. 14(b).

In order for the user input unit 370 to be placed at an accurate position inside the housing 310, a guide rib 317 may be further added to the inner surface of the housing 310 to guide the position of the top and left/right sides of the first input unit 371. That is, a seating unit surrounded by a guide rib 317 may be formed on the inner surface of the housing 310.

In order to fix the first input unit 371 to the housing 310, an adhesive tape 3742 positioned between the inner surfaces of the housing 310 may be further included, as shown in FIG. 13(b). A pressing jig can be used to ensure that the first input unit 371 is brought into close contact with the housing 310 through the adhesive tape 3742.

The pressing jig 30 is a member that is inserted into the housing 310 and presses the user input unit 370 to the inner surface of the housing 310 to couple the first input unit 371 and the housing 310. When the soft material is inserted into the housing or a rigid material is used, such material is inserted into the housing 310, is pressed by rotation of the housing 310, and is pressed in the direction of the user input unit 370, so that the user input unit 370 can be pressurized.

After removing the pressing jig 30, the carrier 315 is inserted, and the FPCB 378 of the user input unit 370 is placed at a lower portion, so that the carrier 315 is inserted and connected to the FPCB 378 and the extra FPCB 378 can be inserted into the carrier 315 and arranged.

Since the carrier 315 is made of a rigid material, the carrier 315 may be caught on the user input unit 370 when the carrier 315 is inserted. Therefore, the upper portion of the seating unit 315c contacting the user input unit 370 may be formed in an open shape without a sidewall. The upper portion of the user input unit 370 is fixed in position by the guide rib 317 formed on the housing 310 and is coupled to the housing 310 through an adhesive tape 3742, so that the upper portion of the user input unit 370 can be omitted.

The carrier 315 may support the back surface of the user input unit 370 so that pressure can be sensed when the second input unit 372 is pressed.

The above detailed description should be construed in all aspects as illustrative and not restrictive. The scope of the present disclosure should be determined by rational interpretation of the appended claims, and all of alternatives, modifications, equivalents, and other embodiments that are included within the equivalent scope of the present disclosure should be construed as falling within the spirit and scope of the present disclosure.

1. A portable electronic device comprising:
a housing; and
a user input unit located inside the housing,
wherein the user input unit includes:
a first input unit disposed in close contact with an inner surface of the housing and configured to detect a touch input; and
a second input unit disposed inside the housing and configured to detect a push input,
wherein the inner surface of the housing includes a first inclined surface.

2. The portable electronic device according to claim 1, further comprising:
a carrier on which the user input unit is seated and inserted into the housing,
wherein the first seating unit on which the first input unit of the carrier is seated includes a second inclined surface corresponding to the first inclined surface.

3. The portable electronic device according to claim 1, further comprising:
a second inclined surface formed on an outer surface of the housing where the first input unit is located, and formed to correspond to the first inclined surface.

4. The portable electronic device according to claim 2, further comprising:
an elastic tape disposed between a rear surface of the first input unit and the carrier.

5. The portable electronic device according to claim 2, wherein:
the carrier includes a second seating unit on which the second input unit is seated, and further includes an elastic pad interposed between the second seating unit and the inner surface of the housing.

6. The portable electronic device according to claim 5, wherein:
the second seating unit includes a vertical surface,
wherein the second seating unit and the first inclined surface of the housing are formed to have a larger upward gap.

7. The portable electronic device according to claim 6, wherein the elastic pad includes:
a first elastic pad located above the second seating part; and
a second elastic pad located below the second seating part and formed to have a larger size than the first elastic pad.

8. The portable electronic device according to claim 1, wherein:
the second input unit is located on an inner surface of the first input unit.

9. The portable electronic device according to claim 8, further comprising:
an elastic adhesive tape disposed between the second input unit and the first input unit.

10. The portable electronic device according to claim 8, wherein the first inclined surface to which the first input unit is coupled further includes:
a first guide rib formed to cover an upper portion and side surfaces of the first input unit.

11. The portable electronic device according to claim 10, further comprising:
a carrier formed to support a rear surface of the user input unit and inserted into the housing,
wherein the carrier further includes:
a second guide rib formed to surround a lower portion and a side portion of the user input unit.

12. The portable electronic device according to claim 1, wherein the housing includes:
a main body in which a sound output unit is mounted; and
an extension portion, one end of which is coupled to the main body, and formed to have the user input unit mounted therein.

13. The portable electronic device according to claim 12, wherein the first input unit includes:
a plurality of electrodes arranged in a longitudinal direction of the extension unit.
